(19) United States
(12) Patent Application Publication
(10) Pub. No.: US 2012/0001403 A1
(43) Pub. Date: Jan. 5, 2012

(54) TRAILER

(76) Inventor: John Wydner, Danville, AL (US)

(21) Appl. No.: 12/827,939

(22) Filed: Jun. 30, 2010

(51) Int. Cl. B62D 63/00; B62D 61/12

(52) U.S. Cl. 280/415.1

(57) ABSTRACT

A trailer has a base and a hitch for connecting the trailer to vehicles. The trailer also has standard wheels at a standard wheel axle left end and a standard wheel axle right end, and can include a castor wheel positioned underneath the base. The standard wheels and the castor wheel provide three support points for the trailer, so the trailer can rest on only the standard wheels and castor wheel. The trailer can be used similar to a cart by moving the trailer on the standard wheels and the castor wheel. The trailer can also include handles, which can allow a user to lift one end and use the trailer similar to a wheelbarrow.

### BACKGROUND OF THE INVENTION

A. Field of the Invention

This invention relates to a trailer, such as those pulled by vehicles.

B. Background of the Invention

Many people bring their trash cans to the side of the road periodically for collection by a trash collection service. This frequently entails moving the trash can from a storage location near a home or workshop to the edge of the road along a driveway or a lane. This distance can be substantial in some cases such that one is required to haul the trash can hundreds of yards from the storage location to the side of the road for collection.

In some locations people will construct protective structures for their trash can to reduce the chance of wildlife disturbing the trash and to reduce the chance of wind or other natural forces disrupting and scattering the trash. These protective structures can be made of wood, plastic, metal or a variety of other materials. In many cases, these protective structures are left close to the road in a location where the trash collection service can access them. Sometimes these protective structures have walls to secure the trash can in place, and they can also be elevated to keep the trash off the ground. It can be challenging to lift the trash can up into these protective structures, especially if the trash is heavy. For transport to the side of the road for collection, some people will roll a trash can with built-in wheels, others will just carry or drag the trash can, and others may utilize a trailer or hitch to connect the trash can to a motorized vehicle.

Trailers are often provided for a specific purpose. There are trailers designed for hauling cattle or livestock, horse trailers, enclosed trailers to protect the contents, flat bed trailers, and a variety of other trailer designs. Trailers designed for one specific purpose are often particularly useful for that specific purpose, but can also be useful for other purposes as well. Some trailers are designed to be relatively small and light weight such that they can be moved by a person without the use of a motorized vehicle. These trailers can be pushed or pulled to various locations for positioning and for moving the trailer as desired. There are also trailers designed for use with non-motorized vehicles, such as bicycles.

Other tools can be used for transporting material as well. One example of such a tool is a cart designed for being pushed or pulled by people, such as a shopping cart. Wheel barrows are also used for transporting material, and there are several different designs of wheel barrows. There are wheel barrows with a single wheel up front and two handles in the back, but there are also wheel barrows with two wheels up front, and various other designs options are also possible.

A structure design to securely hold garbage cans should be sized such that there is no significant distance between the edges of the garbage cans and the structure. The garbage cans should also have lids to prevent access while in the storage structure. When there is little free space between the garbage cans and the structure, the garbage cans cannot move and thereby build up momentum. This reduces the chance of the garbage cans being captured by the wind and flipped out of the structure, or being rapidly moved within the structure to cause an impact capable of denting the garbage can or perhaps knocking the lid off the garbage can.

### BRIEF SUMMARY OF THE INVENTION

A trailer has a base and a hitch for connecting the trailer to vehicles. The trailer also has standard wheels at a standard wheel axle left end and a standard wheel axle right end, and can include a castor wheel positioned underneath the base. There can be movable handles connected to the trailer, and the hitch can be retractable, so the trailer can be used similar to a wheelbarrow by retracting the hitch and lifting on the handles.

### BRIEF DESCRIPTION OF THE DRAWINGS

FIG. 1 is a perspective view of one embodiment of the trailer.

FIG. 2 is a side view of one embodiment of the trailer.

FIG. 3 is a perspective view of trash cans in one embodiment of the trailer.

FIG. 4 is a perspective view of one embodiment of the slide plate housing and castor, wheel ready to be connected.

FIG. 5 is a side view of one embodiment of the slide plate housing and castor wheel ready to be connected.

FIG. 6 is a side view of one embodiment of the receiver tube and hitch.

FIG. 7 is an exploded side view of an embodiment of the gravity assist plunger pin.

FIG. 8 is a side view of one embodiment of the hitch.

FIG. 9 is an exploded perspective view of one embodiment of the trash can connector.

FIG. 10 is a perspective view of one embodiment of the trash can connector with two trash cans.

FIG. 11 is a perspective view of an alternate embodiment of the trailer.

### DETAILED DESCRIPTION

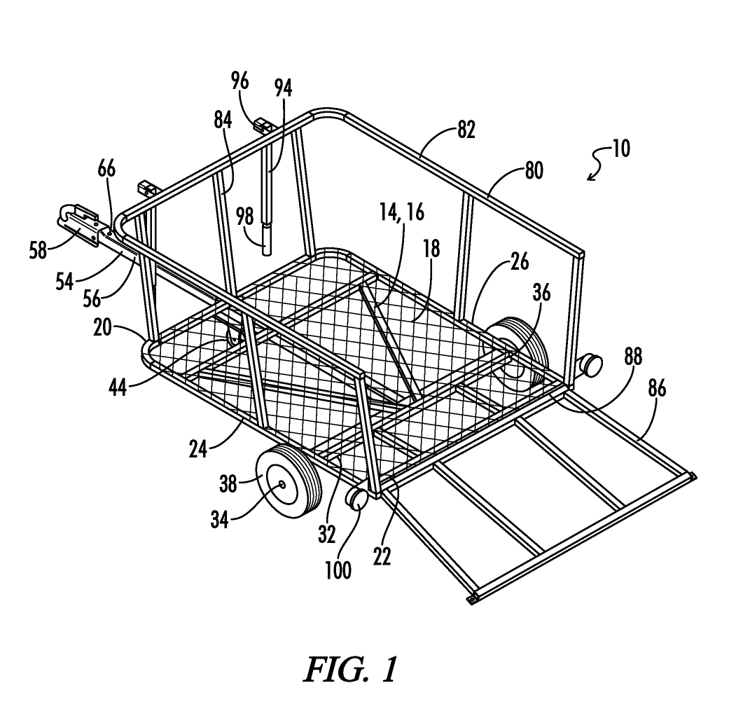

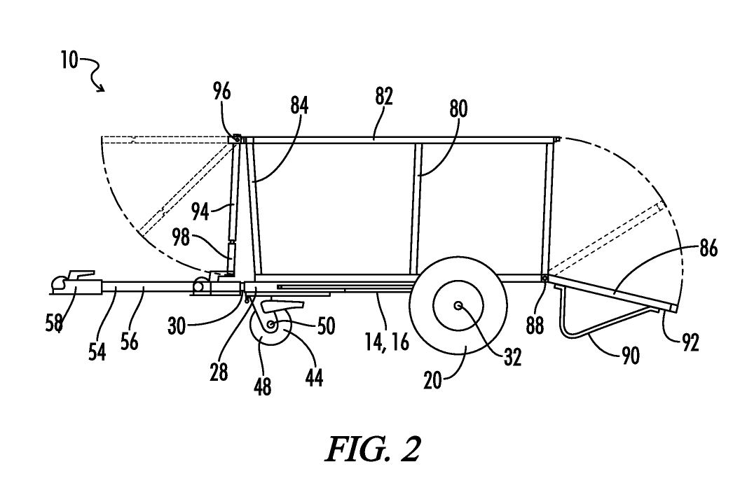

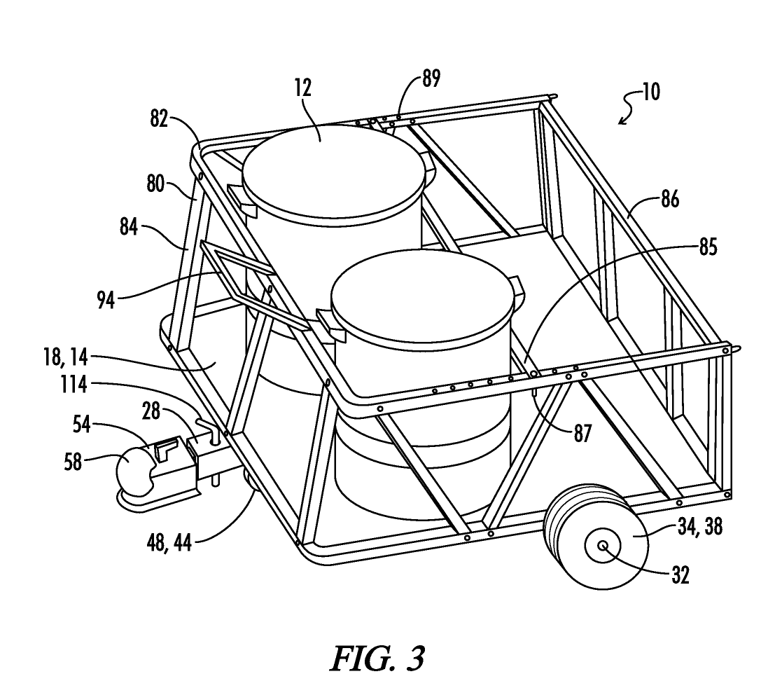

The current invention comprises a trailer designed to be hauled behind a vehicle. However, the trailer also has components which allow it to be used as a cart or wheel barrow, so the current invention provides a multi-purpose trailer. In one embodiment, the trailer 10 has three points of contact with the ground, as seen in FIGS. 1-3. In this embodiment, the three points of contact are not in a single line, but instead form a triangle. The trailer 10 can rest while being supported by these three points of contact with the ground, because three points which are not in a line provides a stable support for an item.

The trailer 10 is also capable of being lifted such that it can be used similar to a wheel barrow. When the trailer 10 is balanced on the three points touching the ground, it can be pushed about by hand similar to a cart. Therefore, the trailer 10 has multiple functions including being hauled behind a vehicle as a trailer 10, being pushed by a person as a cart, and being lifted and rolled as a wheel barrow.

In one embodiment, the trailer 10 is specifically designed to be used with trash cans 12. The trailer 10 is dimensioned and sized such that the trash cans 12 will fit within the trailer 10 with little space between the edge of the trash cans 12 and the trailer 10. This provides for secure storage of the trash cans 12. In one embodiment, the free space between the trailer 10 and trash cans 12 does not exceed 3 inches. The trailer 10 is also designed for easy access to the trash cans 12 to facilitate loading and unloading. The trailer 10 allows for trash cans 12 to be stored out of the way, and then placed near the road on a trash pick up day, so trash cans 12 can usually be kept out of view for aesthetic purposes. The trash cans 12 can also be positioned close to a house or work shop, which may provide easier access for routine use. The trailer 10, although designed and sized specifically for trash cans 12 in one embodiment, will also function as a trailer 10 for many other uses, such as hauling a 4 wheeler or storing lumber. The design does allow for a multi-functional trailer 12 which can be used for a wide variety of purposes.

### Base

The trailer 10 includes a base 14 which supports a load carried in the trailer 10. The base 14 is an essentially flat portion which is generally parallel with the ground. The base 14 can include support framework 16 for strength. This framework 16 can be comprised of tubular steel, wood, angle iron, or a wide variety of other materials. If tubular metal is used for the framework 16, the tubes can be round, square, rectangular, or any of a wide variety of other shapes. The base 14 can also include a support floor 18. The support floor 18 is a relatively flat surface which is or can be supported by the support framework 16 and provides a relatively flat surface for the bed of the trailer 10. Positioning the support floor 18 on top of the support framework 16 can provide a flat surface, which can facilitate loading and unloading of the trailer 10. In one embodiment, the support floor 18 is a mesh material, such as a metal mesh including expanded metal. In alternate embodiments, the support floor 18 can be sheet metal, wood, or a wide variety of other materials.

The base 14 also includes a base front end 20, a base back end 22, a base left side 24, and a base right side 26. The base front end 20 is the portion of the base 14 which would be closest to a vehicle when the trailer 10 is connected to a vehicle. The base right side 26 would be on the right side of the trailer 10 when facing forward from the base back end 22 towards the base front end 20. The base left side 24 is opposite the base right side 26, and the base back end 22 is opposite the base front end 20.

The base 14 can also include a receiver tube 28. The receiver tube 28 may form a portion of the base 14. The receiver tube 28 can form a portion of the support framework 16, and the support framework 16 is part of the base 14. The receiver tube 28 can be positioned below many components of the support framework 16 and still provide support for the bed of the trailer 10, and serve as a part of the support framework 16. The receiver tube 28 can be tubular steel, but it can also be u-shaped steel, triangular, or a wide variety of other shapes. The receiver tube 28 includes a receiver tube opening 30 near the base front end 20. The receiver tube opening 30 opens toward the front end of the trailer 10, which means the receiver tube opening 30 faces forward. Having the receiver tube opening 30 facing forward allows one to insert an object into the receiver tube 28 from in front of the trailer 10.

### Wheels

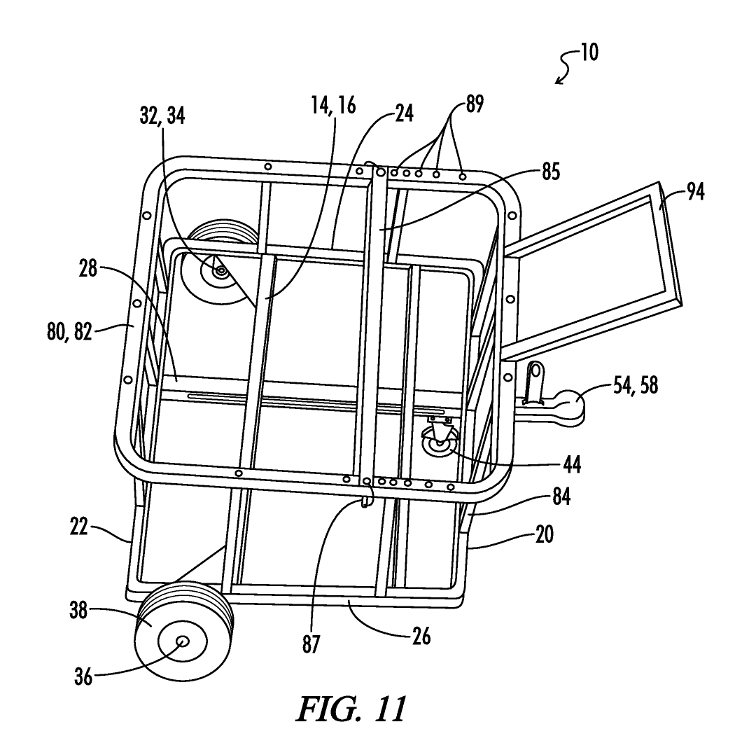

The trailer 10 also includes a plurality of wheels. The trailer 10 can include a standard wheel axle 32 which has a standard wheel axle left side 34 and a standard wheel axle right side 36. A standard wheel 38 is rotatably mounted at the standard wheel axle left side 34, and another standard wheel 38 is rotatably mounted at the standard wheel axle right side 36. In an alternate embodiment, there can be an additional axle with additional standard wheels 38. In yet another possible embodiment, there can be two or more standard wheels 38 rotatably mounted at the standard wheel axle left side 34 as well as two or more standard wheels 38 rotatably mounted at the standard wheel axle right side 36. In some embodiments, it is possible for the standard wheel axle 32 to extend completely under the bed of the trailer 10 from the standard wheel axle left side 34 to the standard wheel axel right side 36. In other embodiments, the standard wheel axle 32 can be split into separate components for the standard wheel axle left side 34 and the standard wheel axle right side 36, as seen in FIG. 11, with continuing reference to FIGS. 1-3. The trailer 10 can include gussets to help support the standard wheel axle 32, or to support other components on the trailer 10.

The standard wheel axle 32 can be removably connected to the base 14. In one embodiment, the standard wheel axle 32 can be connected to the base 14 with bolts, screws, u-bolts, straps or other devices, so the standard wheel axle 32 can be removed from the trailer 10, and thereby interchangeable axles can be used. The trailer 10 can utilized with more than one type of axle, including light duty axle which can be replaced with a road axle. Certain customers may prefer a light duty axle, which can reduce the cost of the trailer 10 as well as reducing the overall weight of the trailer 10 to some extent. Other users may prefer a road axle such that the trailer 10 may be connected to a vehicle and used on public roadways. Still other users may prefer separate standard wheel axles 32 for the standard wheel axle left side 34 and the standard wheel axle right side 36, which can reduce overall trailer weight.

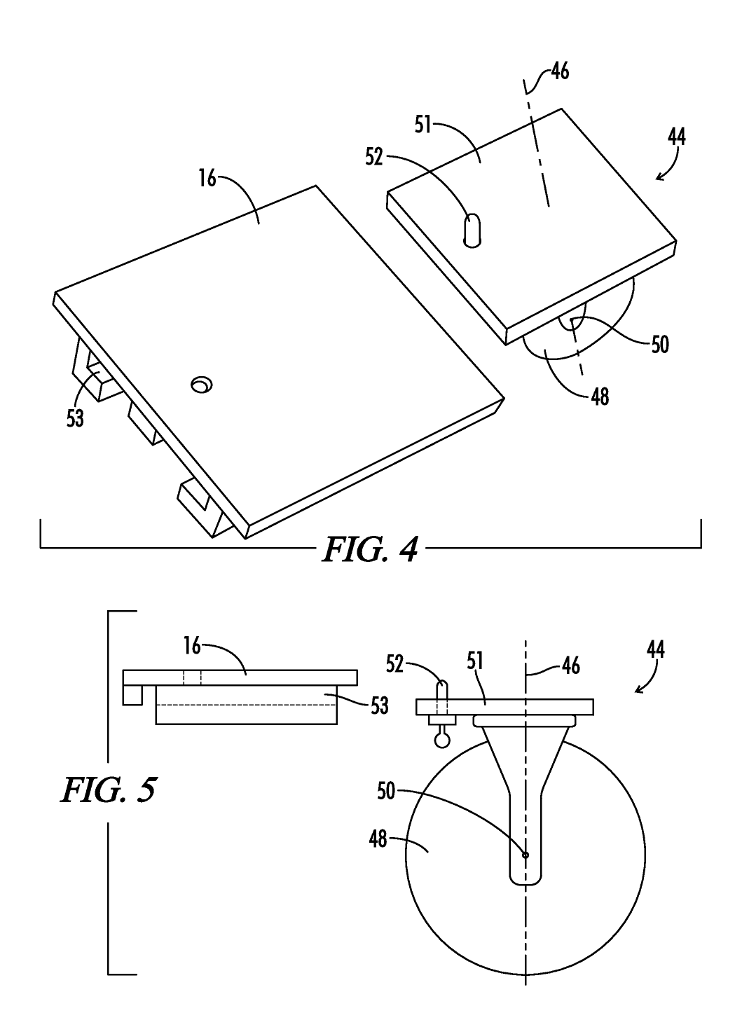

In one embodiment, the trailer 10 also includes a castor wheel 44, which can be rotatable about a vertical axis 46, as seen in FIGS. 4 and 5, with continuing reference to FIGS. 1-3. The castor wheel 44 can rotate about the vertical axis 46 to roll freely regardless of the direction the trailer 10 is moved. Therefore, the overall forces exerted on the trailer 10 and the movement of the trailer 10 can cause the castor wheel 44 to rotate about the vertical axis 46. The castor wheel 44 comprises several parts, including a castor tire 48 which is rotatable about a castor axle 50. The castor tire 48, and all tires on the trailer 10, can be pneumatic, solid, or any other type of tire as desired. The castor wheel 44 can include a single castor tire 48, but in other embodiments it is possible for the castor wheel 44 to include two or more castor tires 48. If the castor wheel 44 includes two or more castor tires 48, it is still referred to as a single castor wheel 44 as long as the castor wheel 44 rotates about a single vertical axis 46. In alternate embodiments, the trailer 10 can include more than one castor wheel 44 as desired.

The castor wheel 44 is preferably positioned underneath the base 14, although placement outside of the base 14 is also possible. In one embodiment, the castor wheel 44 is directly connected to the receiver tube 28. The receiver tube 28 can be a portion of the support framework 16 and is generally a part of the base 14 in embodiments which include the receiver tube 28. In alternate embodiments, the castor wheel 44 can be connected to different portions of the support framework 16 as desired.

The castor wheel 44 can be removably connected to the base 14. The castor wheel 44 can be connected to the base 14 with a quick release, where the quick release uses a single connector to secure the castor wheel 44 in place. One example of a quick release is where the castor wheel 44 includes a slide plate 51 which slides into and out of a slide plate housing 53. The slide plate 51 can be held in position in the slide plate housing 53 using a castor wheel pin 52, so the castor wheel 44 can be secured with the single castor wheel pin 52. The castor wheel pin 52 is the single connector, because it prevents the slide plate 51 from freely sliding within the slide plate housing 53. It is also possible to hold the castor wheel 44 on the slide plate 51 with a bolt, screw, or other device. Other quick release mechanisms are also possible, such as a lever and cam, a pin securing an insert into a receptacle, and many other examples. Other techniques can also be used to secure the castor wheel 44 to the base 14, such as the use of bolts where the castor wheel 44 is bolted directly to some portion of the base 14.

Providing a castor wheel 44 which is removably connected to the base 14 allows one to remove the castor wheel 44 from the trailer 10 for highway travel. When the trailer 10 is connected to a motorized vehicle for highway travel, removal of the castor wheel 44 can prevent damage to the castor wheel 44 as well as preventing interference with the rolling motion of the trailer 10. A quick release, such as the slide plate 51 and castor wheel pin 52, allows for quick and simple attachment of the castor wheel 44, so the user is more inclined to take the effort to remove the castor wheel 44 when recommended.

In one embodiment, the trailer 10 includes one castor wheel 44 positioned underneath the base 14 where the castor wheel 44 is not in line between the standard wheels 38 connected to the standard wheel axle 32. This provides a trailer 10 with 3 support points provided by the wheels of the trailer 10, where the trailer wheels include the standard wheels 38 and the castor wheel 44. The castor wheel 44 can also be equipped with a brake to help keep the trailer 10 from moving. The brake can be manually foot activated, or manually hand activated, or automatically activated, or other techniques can be used for brake operation. The brake can be particularly useful when the trailer 10 when used as a cart, but the brake can also be useful at other times.

### Hitch

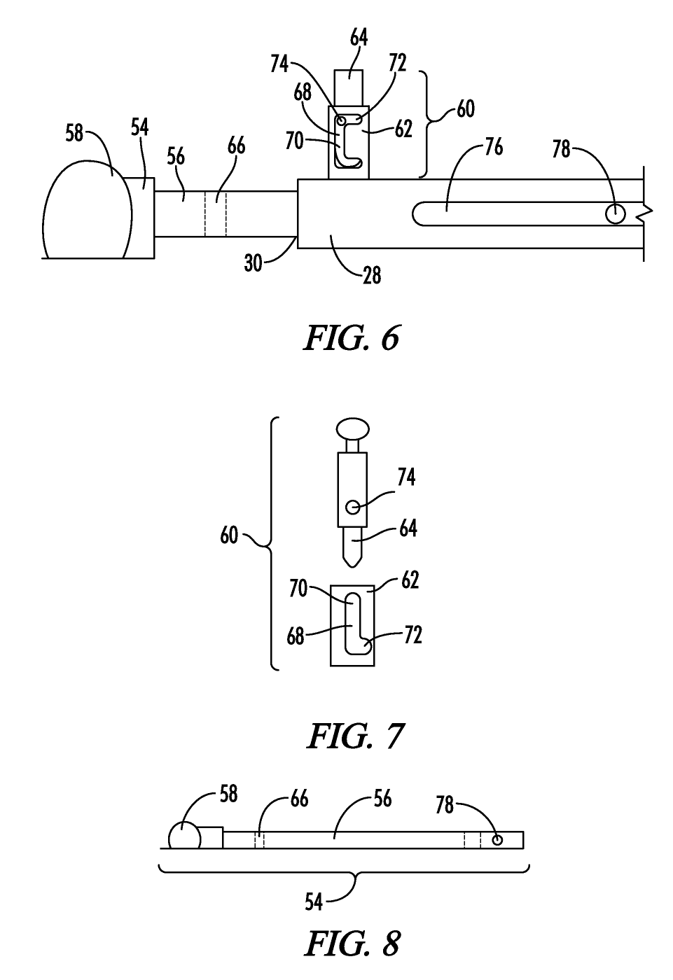

The trailer 10 includes a hitch 54, where the hitch 54 comprises a tongue 56 and a coupler 58, as seen in FIGS. 6-8, with continuing reference to FIGS. 1-5. The coupler 58 is a device which can be connected to a vehicle for hauling the trailer 10. The tongue 56 is an extension which connects the coupler 58 to the bed of the trailer 10. The coupler 58 is generally connected to the front portion of the tongue 56. The coupler 58 can be a ball coupler in one embodiment, but it is also possible for the coupler 58 to be a pin coupler or any of a wide variety of other couplers as desired.

In one embodiment, the hitch 54 is retractably connected to the trailer 10. In this description, the term “retractable hitch” refers to a hitch 54 which moves between an extended position and a retracted position, where the term “retracted position” is defined to mean a position where the coupler 58 is positioned closer to the trailer 10 than in the extended position. A hitch 54 with a hinge is one embodiment of a retractable hitch 54, so in the retractable hitch 54 with a hinge, the hinge is one component of the hitch 54. When the hitch 54 includes a hinge, the hitch 54 can pivot out of the way and provide freer access to the base 14 from the base front end 20. For example, the hitch 54 can move from a generally horizontal position (as shown in FIGS. 1-3) to a generally vertical position. The retractable hitch 54 with a hinge can also include a catch to hold the hitch 54 in the retracted position, so the hitch 54 doesn't fall or move unexpectedly. When the hitch 54 is retractably connected to the trailer 10, the castor wheel 44 is preferably positioned under the base 14, and can be directly connected to a portion of the support framework 16. In this embodiment, the castor wheel 44 is not connected directly to the hitch 54. This allows for the hitch 54 to be retracted out of the way for manual movement of the trailer 10. When the hitch 54 is retracted, a person can easily move across the front of the trailer 10 without having to step over the hitch 54, or walk around the hitch 54. Therefore, one can move across the front of the trailer 10 while pushing the trailer 10 on the three wheels, which allows one to manually maneuver the trailer 10 quite easily. Positioning the castor wheel 44 under the base 14, instead of on the hitch 54, allows for a three point rolling support of the trailer 10 while the hitch 54 is retracted for easier access along the front of the trailer 10, and this can facilitate greater manual maneuverability of the trailer 10.

In an alternate environment, one can slide the tongue 56 into the receiver tube 28 such that the hitch 54 slides back into the base 14. A hitch 54 which can slide into the receiver tube 28 provides for a retractable hitch 54 which allows for easier access to the base front end 20. The receiver tube 28 can be part of the base 14, and not part of the hitch 54. The retractable hitch 54 may allow for variable positioning of the trailer 10 relative to a vehicle, such as if the retractable hitch 54 can be coupled to a vehicle with variable tongue lengths. Also, retracting the hitch 54 allows one to position the trailer 10 with the base front end 20 close to a building or structure, because the hitch 54 will not extend from the base front end 20 when retracted.

In the embodiment where the tongue 56 slides into the receiver tube 28, it is preferred that the receiver tube 28 not be round such that the orientation of the hitch 54 can be maintained in a desired position. The shape of the tongue 56 should generally match the shape of the receiver tube 28, or at least be such that the tongue 56 is not able to rotate within the receiver tube 28. There can also be a tongue slot 76 in the receiver tube 28. A shoulder bolt 78 can be connected to the tongue 56 and protrude through the tongue slot 76 to help secure and guide the tongue 56 as it moves within the receiver tube 28.

In one embodiment, the tongue 56 freely slides into the receiver tube 28. This means there are no gears or other mechanisms used to slide the tongue 56 in and out of the receiver tube 28, and the tongue 56 can be simply pushed directly into the receiver tube 28 and/or directly pulled out of the receiver tube 28 without any additional moving parts. This provides for a retractable hitch 54 where the only moving part for retracting the hitch 54 is the motion of the hitch 54 itself.

The hitch 54 can be set at different positions relative to the bed of the trailer 10. Having at least two different receptacles 66 provides at least two different positions for the tongue 56. It is also possible to provide three or more receptacles 66 such that three or more tongue positions are possible. The tongue 56 and the hitch 54 have at least an extended position and a retracted position. The extended position is where the tongue 56 protrudes from the receiver tube 28 to provide some distance between the coupler 58 and the base front end 20. In this embodiment, the coupler 56 is positioned relatively close to the base front end 20 in the retracted position. The extended position is generally used for connecting the trailer 10 to a vehicle for transportation, and the retracted position is generally used for storage and hand movement of the trailer 10. There can also be intermediate positions for other uses, such as connecting the trailer 10 to a 4-wheeler or other smaller motorized vehicle for hauling, where an intermediate length for the hitch 54 may be desirable.

In one embodiment, the hitch 54 can slide in and out of the receiver tube 28 and can be held in position by a gravity assist plunger pin 60. The gravity assist plunger pin 60 includes a connector pin 64 slidably positioned within a housing 62. The housing 62 can be mounted on top of the receiver tube 28 with a vertical orientation such that the connector pin 64 is able to slide vertically within the housing 62. A hole can be provided in the receiver tube 28 directly underneath the housing 62 such that the connector pin 64 is able to penetrate the receiver tube 28 and extend to at least some distance into the space within the receiver tube 28. The tongue 56 can also include at least two receptacles 66 which are defined along the tongue 56, where the receptacles 66 can be defined along a top portion of the tongue 56. In use, the connector pin 64 will slide down within the housing 62, through the hole in the receiver tube 28, and slide into the receptacle 66 to secure the tongue 56 relative to the receiver tube 28.

The gravity assist plunger pin 60 uses gravity to urge the connector pin 64 into the tongue 54 and into the receptacle 66 within the tongue 56. This allows one to slide the tongue 56 into position, and the gravity assist plunger pin will lock the tongue 54 into the proper position without manually operating the gravity assist plunger pin 60. The gravity assist plunger pin 60 can also include a slot 68 on a side of the housing 62, and this slot 68 can have a slide portion 70 and one or more catch portions 72. The slot slide portion 70 is a relatively vertical portion, and the slot catch portion 72 is more horizontal. There can also be a guide pin 74 connected to the connector pin 64 and protruding through the slot 68. This allows control of the connector pin 64 within the housing 62 by grasping and moving the guide pin 64 up and down in the slot slide portion 70. This also allows a user to secure the tongue 56 in a locked position by moving the guide pin 64 into the slot catch portion 72, where the connector pin 64 protrudes into a receptacle 66 when the guide pin 64 is in the slot catch portion 72. It is also possible to use other connectors, pins, bolts, and various devices known in the art for securing the tongue 56 within the receiver tube 28 as desired.

### Side Support

The trailer 10 can also include a side support 80. The side support 80 can be comprised of rods, sheet metal, mesh, wood, tubular steel, or a wide variety of materials. In one embodiment, the side support 80 comprises a rail 82 and rail supports 84 which connect the rail 82 to the base 14. In one embodiment, the rail 82 has one portion which extends in front of the base front end 20, one portion which extends to the right of the base right side 26, and a portion which extends to the left of the base left side 24. This provides for a tapered shape of the side supports 80, where the side supports 80 taper from a wider area at the rail 82 to a smaller area at the base 14. In an alternate embodiment, the rail 82 is positioned directly over the base 14. In this embodiment, the side supports 80 extend vertically from the base 14 to the rail 82 with no taper, as seen in FIG. 11 with continuing reference to FIGS. 1-8.

Many trash cans 12 can have a tapered shape, and the tapered side supports 80 can provide for a better fit between the trash cans 12 and the trailer 10. The tapered side supports 80 can also allow for a plurality of trailers 10 to be stacked in a nested manner, so more trailers 10 can be positioned within a limited area or space.

To facilitate the fit between the trash cans 12 and the trailer 10, a cross bar 85 can be used. The cross bar 85 can be connected to the side support 80 such that the cross bar 85 extends across the trailer 10. The cross bar 85 can be adjustable, where a cross bar pin 87 secures the cross bar 85 to the rail 82. The cross bar pin 87 can be inserted into one of a plurality of cross bar pin holes 89, where the cross bar pin holes 89 are in various positions along the rail. An adjustable cross bar 85 that extends across the trailer 10 can be positioned to limit the distance between the trash cans 12 and the rail 82 and cross bar 85. Even if the side supports 80 are not tapered, a small distance between the trash cans 12 and the rail 82 and cross bar 85 can reduce the likelihood of the trash cans 12 toppling out of the trailer 10. The cross bar 85 can be secured to the rail 82 or side supports 80 with other techniques as well, such as a clamping bar positioned over the cross bar 85 and holding the cross bar 85 down onto the rail 82, or a bolt that secures the crossing bar 85 to the rail 82.

In one embodiment, side support 80 is comprised of a rail 82 with rail supports 84, but the side support 80 can also include some form of paneling between the rail 82 and base 14. The paneling can be another material which is used or supported by the rail 82, rail supports 84, and possibly by the base 14 as well. This can include metal mesh, sheet metal, wood or other materials as desired.

The trailer 10 can also include a tail gate 86. The tail gate 86 can be secured to a back portion of the side supports 80 such that the tail gate 86 forms a portion of the supports which secure the load within the trailer 10. The tail gate 86 can be hingedly connected to the base back end 22 using a hinge 88. The tail gate 86 can open to a point where the back end of the tail gate 86 touches the ground and makes a ramp such that one can slide or roll garbage cans 12 or other materials on and off the trailer 10. When the tail gate 86 is opened such that the back portion of the tail gate 86 touches the ground, the tail gate 86 is said to be in a loading position. Structural framework can be included in the tail gate 86 for increased strength, because the tail gate 86 can serve as a loading ramp for the trailer 10. The tail gate 86 and/or rail 82, rail supports 84, and side supports 80 can also include connectors for securing the tail gate 86 in a closed position as desired. In an alternative embodiment, the tail gate 86 can be secured in a closed position using other devices, such as a chain, a hinged rail, or a bar.

In one embodiment, the tail gate 86 includes a stand off bracket 90. When the tail gate 86 is in the loading position, the surface of the tail gate 86 which is closest to the ground is referred to as the bottom side 92. The stand off bracket 90 extends from the tail gate bottom side 92 to a position relatively close to the ground when the tail gate 86 is in the loading position. The stand off bracket 90 can help support and stabilize the trailer 10 for loading and unloading operations.

### Additional Components

The trailer 10 can also include one or more handles 94. The handle 94 can be retractable such that the handle 94 has an extended position and a retracted position. In the extended position, the handle 94 protrudes from the trailer 10 and in the retracted position the handle 94 remains relatively close to the body of the trailer 10. Having the handle 94 retract to a position close to the body of the trailer 10 allows for easier access around the trailer 10, because one does not have to walk around the protruding handle 94. In one embodiment, the handle 94 can be hingedly connected to the trailer 10 using a handle hinge 96. In an alternate embodiment, the handle 94 can be slidably connected to the trailer 10 similar to the mechanism described for the slidable connection of the tongue 56 and the receiver tube 28.

In an alternative embodiment, the handle 94 can be fixedly connected to the trailer 10. The handle 94 can be angled up and out from the trailer 10, so that the handle 94 is a more comfortable position for pushing the trailer 10 as a cart. Angling the handle 94 up and out from the cart 10 can also position the handle 94 close to chest level for an adult, which can make it easier for the adult to extend their arms out from the body while using the cart 10. Extending the arms while using the cart 10 can reduce the chances for a user to stumble over the hitch 54, which makes the trailer 10 safer to use. It is also possible for a fixed handle 94 to extend flat or even downward from the trailer 10, as desired. A handle 94 which extends downward from the trailer rail 82 can be more conveniently positioned for using the trailer 10 as a wheel barrow.

The handle 94 is preferably not connected to the hitch 54, but is connected to other portions of the trailer 10. The handle 94 is preferably connected to one or more of the side supports 80, the tail gate 86, or the base 14. Connecting the handle 94 to the side support 80, tail gate 86, or base 14 can be preferable to connecting the handle 94 to the hitch 54 because the hitch 54 can be retracted out of the way for manual movement of the trailer 10, so the handle 94 can remain accessible when the hitch 54 is retracted. Additionally, the handle 94 can be positioned to reduce back strain for the user, where the hitch 54 is often positioned to facilitate towing of the trailer 10. The handle 94 can be positioned on the same side of the trailer 10 as the castor wheel 44, so when one lifts the trailer 10 with the handle 94, the castor wheel 44 looses contact with the ground. In one embodiment, the handle 94 is on the front end of the trailer 10, and the castor wheel 44 is also near the front end of the trailer 10.

The movable handle 94 can lock in an extended position to facilitate lifting of the trailer 10. When not in use, the movable handle 94 can be repositioned to avoid obstructing movement near the trailer 10. The movable handle 94 can include a handle 94 with hinges, a handle 94 which retracts into a receiver, a telescoping handle 94, a removable handle 94, or other techniques which allow the handle to be positioned in an extended position and a position that avoids obstruction of movement near the trailer 10. In this description, the term “collapsed position” refers to the position of the handle 94 that avoids obstruction of movement near the trailer 10. In the collapsed position, the handle 94 preferably does not extend beyond the side supports 80 to an appreciable extent, and in the extended position the handle 94 extends beyond the side supports 80 more than in the collapsed position.

Many different mechanisms can be used to lock the handle 94 in the extended position, including a hinge stop, a chain, and a handle 94 which slides into a receiver. When the handle 94 is locked and in the maximum extended position, further lifting of the handle 94 lifts the base 14. One can use the handle 94, once locked in the extended position, to maneuver the trailer 10 similar to a wheel barrow where one lifts one side of the trailer 10 and physically pushes or pulls the trailer 10 on the wheels touching the ground. If the handle 94 is one the same side of the trailer 10 as the castor wheel 44, the wheels touching the ground would be the standard wheels 38. The handles 94 can also be used to push the trailer 10 similar to a cart as desired. Use of the trailer 10 as a wheel barrow can be better for rough surfaces, and use of the trailer 10 as a cart may be easier with smooth surfaces.

To facilitate use of the handles 94, grips 98 can be included as well. The trailer 10 can include one or more handles'94 as desired, and the handles 94 can be positioned on one or more sides of the trailer 10 as desired. Additional components which can be included with the trailer 10 include lights 100, which can be part of a road package to make the trailer 10 legal for public roadway use. Other additional components can include brakes for stopping the trailer, retractable support legs which can be used to support the trailer 10 especially in embodiments with no castor wheel 44, a storage compartment, and a fender. A wide variety of other components can also be added to the trailer 10, as is understood by those skilled in the art.

The entire trailer 10 can be disassembled and packed in boxes for shipping. Connectors can be included with the trailer for assembly, such as nuts and bolts, screws, pins, etc. The relatively small size and light weight of the trailer 10 make disassembly, packaging, and shipping by conventional means a viable method of delivery.

### Trash Can Connector

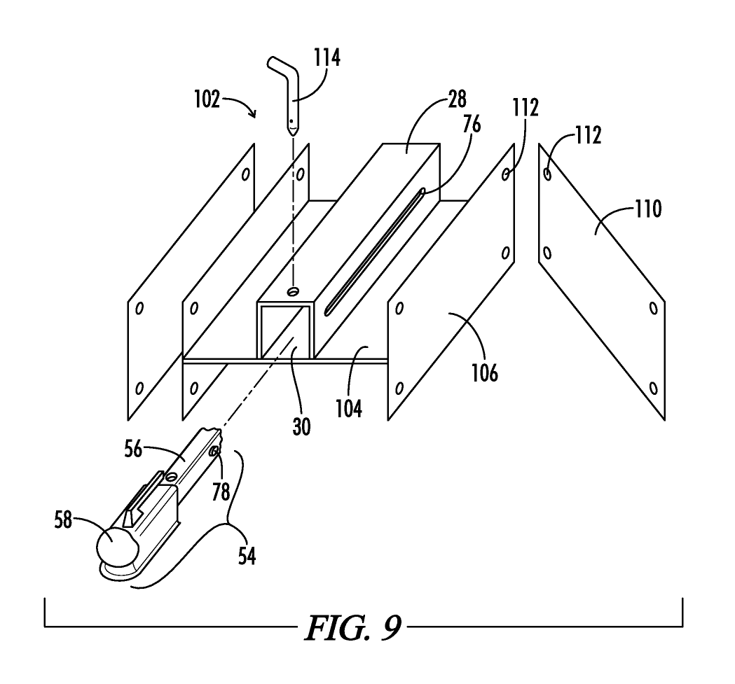

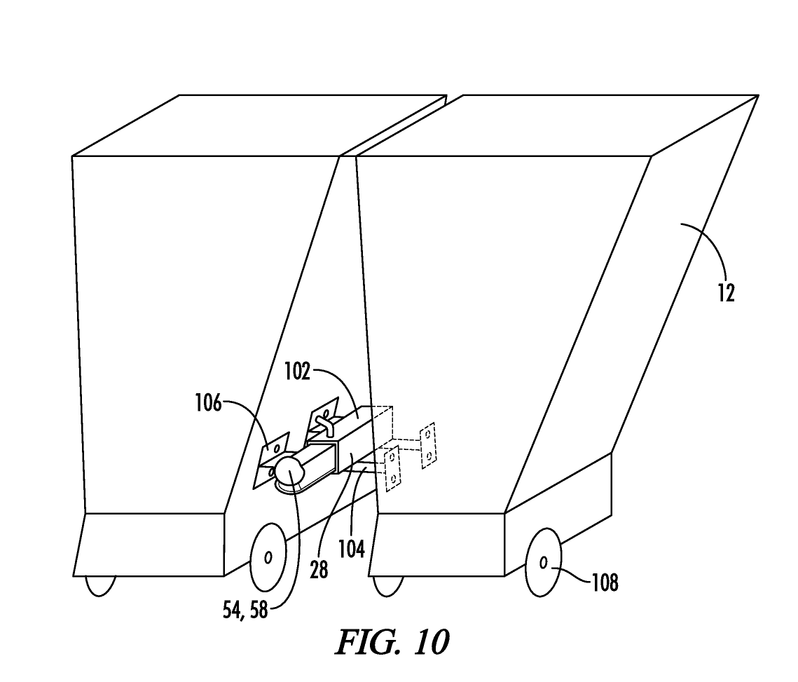

In an alternate embodiment, a trash can connector 102 can be used to secure trash cans 12, as seen in FIGS. 9 and 10, with continuing reference to FIGS. 1-8 and FIG. 11. The trash can connector 102 is a device that allows one to connect at least two trash cans 12 together, and provides a hitch 54 for transporting the connected trash cans 12. When two or more trash cans 12 are connected together, each trash can 12 is stabilized by the other so there is less chance of wind or physical contact knocking a trash can 12 over. The increased stability from connecting a plurality of trash cans 12 reduces the chances of the trash being disrupted, and also allows for simultaneous transportation of the plurality of trash cans 12, which saves trips from a trash can storage location to the side of the road on a designated trash pick-up day. Simultaneous transport of several trash cans 12 makes removing the trash cans 12 from the side of the road to a more discrete location easier, so a resident can improve the appearance of their residence by moving trash cans 12 out of sight. Movable trash cans 12 may be easily positioned closer to the house to facilitate routine access, and then be moved more distant from the house to the side of the road until the trash is picked up by the local trash service. Trash collection services may remove trash from the trash cans 12 by pulling out individual bags of trash, but techniques to dump trash cans 12 connected together may also be available.

Many trash cans 12 include wheels 108, so using the trash can connector 102 to connect two or more trash cans 12 together can provide a mechanism for simultaneously towing the plurality of trash cans 12. The trash can connector 102 can include a connector plate 104, a hitch 54, and a plurality of trash can plates 106 for connection to the trash cans 12. When connected to the trash cans 12, the trash can connector 102 serves to make the trash cans 12 into a towable unit. Connecting the hitch 54 to a vehicle can allow one to simultaneously tow every trash can 12 connected to the trash can connector 102. Positioning the hitch such that a lifting action is required to connect to a vehicle can tilt the trash cans 12 so that only the trash can wheels 108 contact the ground. This tilting action allows a user to tow the trash cans 12 using the trash can wheels 108, so the trash cans 12 aren't dragged along the ground. This can reduce noise during transport, and extend the life of a trash can 12, because the trash can 12 is designed to be moved using the trash can wheels 108.

The trash can plate 106 is used to connect the trash can connector 102 to a plurality of trash cans 12. The trash can connector 102 can include two or more trash can plates 106 for connection trash cans 12 to the trash can connector 102. In some embodiments, the trash can connector 102 includes two trash can plates 104, so two trash cans 12 are connected together, but in other embodiments the trash can connector can include four trash can plates 104 so four trash cans 12 are connected together. It is even possible to provide kits so a trash can connector 102 can be converted from a two trash can device to a four trash can device. In yet other embodiments, the trash can connector 102 can be designed for three trash cans 12, five or six trash cans 12, or essentially any other number of trash cans 12 desired.

The trash can plates 106 can be dimensioned to connect to a trash can 12, and can be angled and shaped to match the contours of a trash can 12. For example, the trash can plate 106 can be flat, and angled to match the slope of the side a relatively square, tapered trash can 12. Alternatively, the trash can plate 106 can be curved to match the contours of a round or oval trash can 12, and can still be angled to match the slope of a tapered trash can 12. The trash can plate 106 can be vertical, which matches the angle of a trash can 12 that extends straight up or down, but a vertical trash can plate 106 can also be used to tilt the trash cans 12 slightly. The trash can plate 106 can be horizontal to connect to the bottom of a trash can 12, or it can extend only generally upward or only generally downward from the connector plate 102. The trash can plate 106 can also extend both upward and downward from the connector plate 102, or it can be shaped and positioned in a wide variety of ways for connecting the trash can connector 102 to a plurality of trash cans 12. The trash can plate 106 can even be a band extending around the trash can 12. The trash can plate 106 can be a single piece, but it can also be comprised of more than one piece, including plates, bars, rods, mesh, or essentially any shape or structure which can connect to a trash can 12.

There can be a trash can backing plate 110 to be used with the trash can plate 106 for connecting trash cans 12 to the trash can connector 102. The trash can backing plate 110 is dimensioned to connect to the trash can plate 106 with the wall of a trash can 12 positioned between the trash can plate 106 and the trash can backing plate 110. The trash can backing plate 110 can be positioned inside the trash can 12, and screws, bolts or other connector scan be inserted through connector holes 112 in each of the trash can backing plate 110, the wall of the trash can 12, and the trash can plate 106. The trash can backing plate 110 can support and spread forces from movement of the trash can connector 102, which can improve the life of a trash can 12 connected to the trash can connector 102.

The connector plate 104 can tie the various components of the trash can connector 102 together. The connector plate 104 can be connected to each trash can plate 104, and can also be connected to the hitch 54. The connector plate 104 can be essentially horizontal when in use, but it is also possible for the connector plate 104 to be angled off of horizontal, or to include bends or curves. The connector plate 104 can be a single piece, but it can also be comprised of several bars, plates, rods, mesh, or other structures, as desired.

The hitch 54 is used to connect the trash can connector 102 to a vehicle. The hitch 54 can be the same as the hitch described above, and includes a tongue 56 and a coupler 58. The hitch 54 can be retractably connected to at least one of the connector plate 104 or a trash can plate 106, such that the hitch has a retracted position and an extended position. In the extended position, the coupler 58 is further from the connector plate 104 than in the retracted position. The retracted position can be used for storage, so the hitch 54 is less obtrusive and doesn't make as much of a tripping hazard when not in use. In the extended position, the hitch 54 is available to connect the trash cans 12 and trash can connector 102 to a vehicle for towing.

As discussed above, the hitch 54 is considered retractable as long as the hitch 54 can move between an extended position and a retracted position. The retracted position for the trash can connector embodiment is where the coupler 58 is closer to the connector plate 104, instead of being closer to the trailer 10 as described for the trailer embodiment. As discussed above, the hitch 54 can be retractable by use of a hinge, or by use of a receiver tube 28, or by other techniques known to those skilled in the art. The receiver tube 28 can include a gravity assist plunger pin 60 as described above, or the hitch 54 can be secured with a simple hitch pin 114, or other techniques can be used to secure the hitch 54 in a desired position.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

1. A trailer comprising:
a base comprising a front end, a back end, a left side, a right side, and a receiver tube, where the receiver tube comprises a receiver tube opening facing forward;
a standard wheel axle connected to the base, the standard wheel axle further comprising a standard wheel axle left end and a standard wheel axle right end;
a standard wheel rotatably mounted at the standard wheel axle left end, and a standard wheel rotatably mounted at the standard wheel axle right end;
a side support comprising a rail and a plurality of rail supports, where the rail supports connect the base to the rail, and where the rail is positioned above the base;
a cross bar connected to the side support such that the cross bar extends across the trailer;
a hitch comprising a tongue and a coupler, where the tongue is slidably positioned within the receiver tube, and the coupler is connected to the tongue and positioned in front of the receiver tube opening;
a castor wheel removably connected to the trailer underneath the base, where the castor wheel rotates about a vertical axis;
a tailgate hingedly connected to the base; and
a movable handle connected to at least one of the group consisting of the side support, the base, the tailgate, and any combination thereof, such that the handle has an extended position and a collapsed position.

2. A trailer comprising:
a base comprising a left side, a right side, and a front end;
a standard wheel axle connected to the base, such that the trailer comprises a standard wheel axle left end and a standard wheel axle right end;
a plurality of standard wheels, where the standard wheel is rotatably mounted at the standard wheel axle left end, and another standard wheel is rotatably mounted at the standard wheel axle right end;
a castor wheel connected to the trailer, where the castor wheel is positioned underneath the base; and
a hitch comprising a tongue and a coupler, the hitch connected to the trailer such that the coupler is positioned forward of the base front end.

3. The trailer of claim 2 where the hitch is retractably connected to the base such that the hitch can be positioned in an extended position or in a retracted position.

4. The trailer of claim 3 where the hitch hingedly connects to the base.

5. The trailer of claim 3 where the base further comprises a receiver tube, and where the hitch slidably retracts into the receiver tube.

6. The trailer of claim 5 further comprising a gravity assist plunger pin, where the gravity assist plunger pin comprises a connector pin slidably positioned in a housing, and where the housing is connected to a top of the receiver tube such that gravity urges the connector pin towards the tongue.

7. The trailer of claim 3 further comprising a movable handle connected to the trailer, such that the handle has an extended position and a collapsed position.

8. The trailer of claim 1 further comprising a handle independent from the hitch.

9. The trailer of claim 2 further comprising a side support extending upward from the base.

10. The trailer of claim 9 further comprising a cross bar connected to the side support, such that the cross bar extends across the trailer.

11. The trailer of claim 2 further comprising a tailgate hingedly connected to the base, where the tailgate comprises a stand-off bracket extending from the tailgate such that the stand-off bracket is near the ground when the tailgate is in a loading position.

12. The trailer of claim 2 where the castor wheel is connected to the base with a quick release, such that a single connector secures the castor wheel in position.

13. The trailer of claim 12 further comprising a castor wheel pin, and where the castor wheel pin secures the castor wheel to the base.

14. A trailer comprising:
a base;
a retractable hitch connected to the base such that the hitch can be positioned in an extended position or in a retracted position; and
a movable handle connected to trailer independent of the hitch such that the handle can be positioned in an extended position or in a collapsed position.

15. The trailer of claim 14 where the base comprises a front end, the base further comprising a receiver tube having a receiver tube opening facing towards the front end of the trailer, and where the hitch slidably retracts into the receiver tube.

16. The trailer of claim 15 further comprising a gravity assist plunger pin, where the gravity assist plunger pin comprises a connector pin and a housing, the connector pin slidably positioned within the housing, the housing mounted to the top of the receiver tube such that gravity urges the connector pin towards the tongue, where the tongue defines at least two receptacles sized to receive the connector pin.

17. The trailer of claim 14 where the handle is hingedly connected to the trailer.

18. The trailer of claim 14 further comprising a standard wheel axle connected to the base, where the standard wheel axle has at least two standard wheels, the trailer further comprising a castor wheel rotatable about a vertical axis independent of the hitch, and where the castor wheel is positioned under the base.

19. The trailer of claim 18 where the castor wheel is connected to the base with a quick release, such that the castor wheel is secured in position with a single connector.

20. The trailer of claim 14 further comprising side surfaces connected to the base, where the side surfaces taper outwardly from the base.

21. A trash can connector comprising:
a connector plate;
a plurality of trash can plates connected to the connector plate, where the trash can plates are dimensioned to connect to a trash can; and
a hitch, where the hitch comprises a tongue and a coupler, and where the hitch is retractably connected to at least one of the connector plate or the trash can plates such that the hitch has a retracted position and an extended position.

22. The trash can connector of claim 21 further comprising a receiver tube connected to the connector plate, where the tongue is slidably positioned within the receiver tube so the hitch can slide out to an extended position or retract to a retracted position.

23. The trash can connector of claim 21 further comprising a plurality of trash cans connected to the trash can plates.

24. The trash can connector of claim 21 further comprising a plurality of trash can backing plates dimensioned to connect to the trash can plates such that a trash can wall can be positioned between the trash can plate and the trash can backing plate.
